(19) United States
(12) Patent Application Publication
(10) Pub. No.: US 2026/0012284 A1
(43) Pub. Date: Jan. 8, 2026

(54) SYSTEMS, METHODS AND APPARATUS FOR SUPPORTING UNEQUAL MODULATION

(71) Applicant: HUAWEI TECHNOLOGIES CO., LTD., SHENZHEN (CN)

(72) Inventors: Sara NOROUZI, Kanata (CA); Jung Hoon SUH, Kanata (CA); Yan XIN, Kanata (CA); Osama ABOUL-MAGD, Kanata (CA); Mahmoud HASABELNABY, Kanata (CA)

(73) Assignee: HUAWEI TECHNOLOGIES CO., LTD., SHENZHEN (CN)

(21) Appl. No.: 18/892,805

(22) Filed: Sep. 23, 2024

Related U.S. Application Data
(60) Provisional application No. 63/668,465, filed on Jul. 8, 2024.

(51) Int. Cl. H04L 1/00; H04B 7/0413; H04W 84/12

(52) U.S. Cl. CPC H04L 1/0003; H04B 7/0413; H04W 84/12

(57) ABSTRACT

An extension for HT Control field is provided to accommodate UEQM and LA parameters. The first m bits of HTC Extension may be used to demonstrate the type of extension. Tables of common UEQM patterns or combinations with high probability can be considered for different number of spatial streams. Delta modulation can be adopted to show UEQM patterns. An index for showing different combinations of delta modulation for streams can be used. A subfield in UHR LA Extension with n bits can be considered for UEQM Pattern Index.

### CROSS-REFERENCE TO RELATED APPLICATIONS

This application claims the benefit of priority to U.S. Application No. 63/668,465, filed Jul. 8, 2024, the contents of which are incorporated herein by reference.

### FIELD OF THE APPLICATION

The present application pertains to the field of wireless communication systems, and in particular to systems, methods and apparatus for supporting unequal modulation (UEQM) in systems such as IEEE 802.11 communication systems.

### BACKGROUND

Multiple antennas can be used at each of a transmitter and a receiver in a technological strategy known as multiple-input, multiple-output (MIMO) to improve wireless communication between the transmitter and receiver. MIMO can enhance the data rate, reliability, and spectral efficiency of the wireless communications. MIMO techniques can include: spatial multiplexing, wherein the multiple antennas of the transmitter simultaneously and independently transmit separately coded data streams; spatial diversity, wherein a same data stream is transmitted from the multiple antennas of the transmitter to improve the reliability of transmission; and beamforming, wherein the amplitude and phase of data streams transmitted from each antenna are adjusted to direct and steer the transmission towards the antennas of the receiver.

MIMO transmissions can comprise multiple spatial streams, each of which may experience a different channel quality. This results in imbalances in signal-to-noise across the spatial streams that can limit the throughput of transmissions. Unequal modulation (UEQM), in which one encoder and different modulations are used for each spatial stream, has been proposed to address this limitation. However, there is a need for methods and apparatus for directing devices to implement UEQM.

Therefore, there is a need for methods and apparatus for enabling UEQM that obviate or mitigate one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

The present disclosure provides systems, apparatus and methods for indicating UEQM parameters.

According to embodiments of the present disclosure, and in order to accommodate UEQM for different spatial streams, some extensions are provided for use in IEEE 802.11 standards, for example the IEEE 802.11bn standard and standards subsequent thereto, for use in generating and reading a medium access control (MAC) header. Embodiments of the present disclosure provide a way for a high-throughput control (HTC) Extension field to indicate the UEQM per each spatial stream in a link adaptation (LA) field. According to embodiments, a UEQM configuration is indicated in the HTC Extension field via a table index. The index indicates an entry in a table, known to both transmitter and receiver, where the entry indicates the UEQM configuration. Different tables are used depending on the number of spatial streams in use. The table lists several modulation patterns (or alternatively modulation and coding scheme (MCS) patterns) that are used with high probability (e.g. the most common modulation patterns or the most likely modulation patterns; the modulation patterns actually used in practice, the patterns that have high (e.g. over a threshold) probability of being chosen for use). Table entries can indicate modulations of spatial streams relative to the modulation of a base stream.

According to an aspect, there is provided a transmitter in an IEEE 802.11 wireless communication system. The transmitter communicates with a receiver using a multiple input multiple output (MIMO) communication involving a plurality of spatial streams, at least two of the spatial streams potentially having unequal modulation (UEQM) relative to one another. The transmitter is configured to transmit a physical layer protocol data unit (PPDU) having a medium access control (MAC) header comprising a high throughput control (HTC) field and a HTC extension field. The HTC extension field indicates a type of modulation of each of the spatial streams other than a base stream of the plurality of spatial streams. The transmitter is configured to transmit each of the spatial streams, other than the base stream, according to the type of modulation corresponding thereto, as indicated in the HTC extension field. The transmitter is configured to transmit the base stream according to a type of modulation as indicated in the PPDU separately from the HTC extension field.

In various embodiments, the HTC extension field indicates the type of modulation of each of the plurality of spatial streams relative to the type of modulation of the base stream.

In various embodiments, the HTC extension field begins with a first one or more bits indicative that the HTC extension field indicates, according to a predetermined format, the types of modulations of each of the plurality of spatial streams other than the base stream. The bits can be set to a predetermined value indicative that the field operates as an Ultra High Reliability (UHR) Link Adaptation (LA) extension, including useful parameters such as MU-MIMO parameters and the UEQM pattern index. If the bits are set to other values, the HTC extension field may carry information for another purpose.

In various embodiments, the HTC extension field includes an index indicating one of a plurality of potential configurations. Each of the plurality of potential configurations is known to both the transmitter and the receiver and corresponds to potential types of modulation for each of the plurality of spatial streams other than the base stream. The mentioned one of the plurality of potential configurations corresponds to the type(s) of modulation(s) of each of the spatial streams other than the base stream.

In various embodiments, the plurality of potential configurations includes less than all possible configurations. In various embodiments, the plurality of potential configurations includes a subset of more likely ones of all possible configurations.

In various embodiments, each of the plurality of potential configurations indicates, for each one of the spatial streams other than the base stream, a difference between the type of modulation of that one of the spatial streams and the type of modulation of the base stream. The difference may be expressed as a modulation order gap or similar numerical value.

In various embodiments, the plurality of potential configurations are known to the transmitter and the receiver via a predetermined correspondence. The predetermined correspondence further depends on a quantity of the plurality of spatial streams.

According to another aspect, there is provided a receiver in an IEEE 802.11 wireless communication system. The receiver communicates with a transmitter using a multiple input multiple output (MIMO) communication involving a plurality of spatial streams, at least two of the spatial streams potentially having unequal modulation (UEQM) relative to one another. The receiver is configured to receive a physical layer protocol data unit (PPDU) having a medium access control (MAC) header comprising a high throughput control (HTC) field and a HTC extension field. The HTC extension field indicates a type of modulation of each of the spatial streams other than a base stream of the plurality of spatial streams. The receiver is configured to receive and process each of the spatial streams, other than the base stream, according the type of modulation corresponding thereto, as indicated in the HTC extension field. The receiver is configured to receive and process the base stream according to a type of modulation as indicated in the PPDU separately from the HTC extension field.

According to another aspect, there is provided a system including at least one transmitter and at least one receiver, each as described above.

In various embodiments, operations such as those described above with respect to the transmitter, or complementary operations thereto, can be performed by the receiver.

According to another aspect, an apparatus is provided, where the apparatus includes modules configured to perform one or more methods described herein. According to another aspect, another apparatus is provided that includes computing electronics and is configured to perform the methods described herein. According to another aspect, another apparatus is provided that includes processing and wireless communication electronics and is configured to operate as described herein. According to another aspect, a system is provided that includes one or more apparatuses as described herein.

According to another aspect, an apparatus is provided, where the apparatus includes: a memory, configured to store a program; a processor, configured to execute the program stored in the memory, and when the program stored in the memory is executed, the processor is configured to perform the methods in the different aspects described herein.

According to another aspect, a method is provided for execution by processing and wireless communication electronics. The method includes performing operations as described herein, for example by a transmitter or a receiver, or system including same. In some embodiments a computer program product is provided. The computer program product includes a non-transitory computer readable medium having recorded thereon statements and instructions which, when executed by a computer, cause the computer to perform one or more methods described herein.

According to another aspect, a chip or chipset is provided, where the chip or chipset includes a processor and a data interface, and the processor reads, by using the data interface, an instruction stored in a memory, to perform the different aspects described herein. Additionally or alternatively, the chip or chipset may include other digital, analog, or digital and analog processing electronics configured to perform the operations as described herein. The chip may operate to direct an associated device to perform transmission or reception operations and supporting operations as described herein.

Other aspects of the application provide for apparatus, and systems configured to implement the methods according to the different aspects disclosed herein. For example, wireless stations and access points can be configured with machine readable memory containing instructions, which when executed by the processors of these devices, configures the device to perform the methods disclosed herein.

Embodiments have been described above in conjunction with aspects of the present application upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present application will become apparent from the following detailed description, taken in combination with the appended drawings, in which:

FIG. 1 illustrates a MIMO configuration according to an embodiment of the present disclosure.

FIG. 2 illustrates an IEEE 802.11 MAC frame format according to the prior art.

FIG. 3 illustrates an IEEE 802.11 HLA/ELA Control Information subfield format, used in embodiments of the present disclosure.

FIG. 4 illustrates an IEEE 802.11 MAC frame format according to an embodiment of the present disclosure.

FIG. 5 illustrates an HTC Extension field in an IEEE 802.11 MAC frame header according to an embodiment of the present disclosure.

FIG. 6 illustrates a method at a transmitter, according to an embodiment of the present disclosure.

FIG. 7 illustrates a method at a receiver, according to an embodiment of the present disclosure.

FIG. 8 is a schematic diagram of an electronic device that may perform any or all of operations of the above methods and features explicitly or implicitly described herein, according to different embodiments of the present application.

FIG. 9 illustrates a communication system, according to an embodiment of the present application.

FIG. 10A illustrates an example apparatus, according to an embodiment of the present application.

FIG. 10B illustrates another example apparatus, according to an embodiment of the present application.

It will be noted that throughout the appended drawings, like features are identified by like reference numerals.

### DETAILED DESCRIPTION

Embodiments of the present disclosure provide details regarding how to indicate the different modulations (e.g. quadrature amplitude modulations (QAM)) for each spatial stream in a (e.g. IEEE 802.11) PPDU, to support a UEQM implementation. The UEQM implementation refers to a MIMO configuration in which different spatial streams are potentially modulated using different modulation types. Although embodiments can be readily adapted to also signal different coding schemes, it is noted that in UEQM, coding rates are typically the same for all spatial streams.

In wireless communications, Multiple Input Multiple Output or MIMO, offers several benefits in terms of data rate, reliability, and spectral efficiency through spatial multiplexing, diversity, and beamforming. Specifically, simultaneous transmission of independent and separately coded data streams using different antennas is called spatial multiplexing.

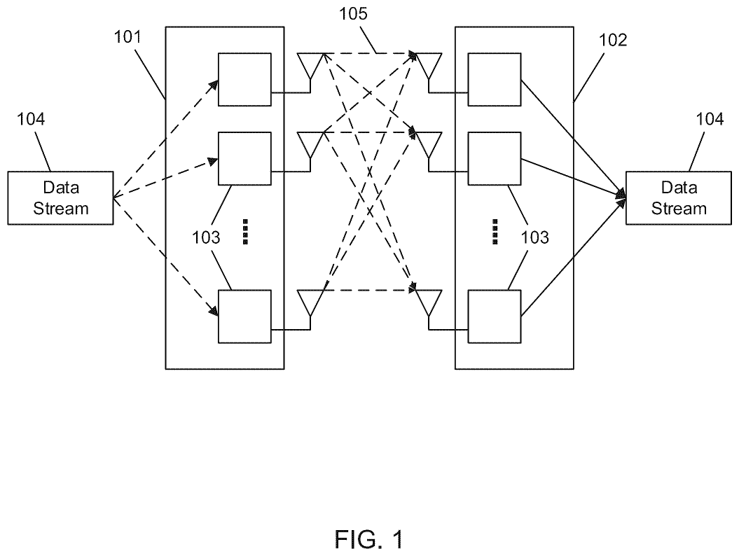

FIG. 1 shows the high-level operation of MIMO techniques, particularly with respect to spatial multiplexing (rather than beamforming or diversity techniques). Here, a transmitter 101 is in wireless communication with a receiver 102. Each of the transmitter 101 and receiver 102 have a respective plurality of antennae 103. The transmitter 101 is configured to receive a data stream 104 and send the data of the data stream 104 to the receiver 102 through a plurality of spatial streams 105 between the respective pluralities of antennae 103 of the transmitter 101 and receiver 102. With spatial multiplexing, each antenna 103 of the transmitter 101 may have an independent and separately coded and/or modulated spatial stream 105 with each antenna 103 of the receiver 102. In FIG. 1, spatial multiplexing of the spatial streams 105 is depicted by the dot-dash, dot-dot-dash, and dot-dash-dash lines between antennae 103.

In effect, each spatial stream may experience different SNRs. Assume a single user (SU) MIMO system in which the transmitter and receiver are equipped with N and M antennas, respectively. The channel coefficients for spatial streams between the transmitter and receiver can be denoted by a channel matrix H∈ [symbol] . The singular value decomposition (SVD) of the channel matrix can be expressed as:

$$H = U Σ {V}^{H}$$

where U and V are two unitary matrices of size M×M and N×N, respectively, and (·)^{H} denotes the conjugate transpose. Σ=diag(λ₁, λ₂, . . . , λᵣ) is an M×N diagonal matrix with r non-negative real numbers on the diagonal, where r≤min(M, N) is the rank of H and λ₁>λ₂> . . . >λᵣ are the singular values.

In SVD-based beamforming, the transmitter multiplies the signal to be transmitted, x̅, with V before sending into the antennas (precoding). The receiver, on the other hand, multiplies the signals received on each antenna, y, by the matrix U^{H} (receiver shaping). The transmitter precoding and receiver shaping transform the MIMO channel into r parallel Single Input Single Output or SISO channels as shown below:

$$\overline{y} = {U}^{H} y = {U}^{H} ( H x + n ) = {U}^{H} ( U Σ {V}^{H} V \overline{x} + n ) = Σ \overline{x} + \overline{n}$$

where n is the additive noise term and n̅=U^{H}n. It can be inferred that the MIMO gain mainly concentrates on the first few spatial streams with larger singular values. Currently, despite proposals in IEEE 802.11n, unequal modulation (UEQM), i.e. using one encoder and different modulation per spatial stream, has not been adopted in practice. However, considering the SNR imbalance, assigning equal modulations/MCSs to different spatial streams results in a suboptimal solution. In recent proposals, it has been shown that using different modulations for spatial streams to adapt to their SNR conditions can achieve higher throughput compared to equal MCS. Moreover, the goodput performance of UEQM is close to optimal solution of unequal MCS, yet with lower complexity.

In U.S. Provisional Patent Application No. 63/568,893, filed Mar. 22, 2024 and hereby incorporated by reference, an HTC Extension field was provided to indicate the modulation for each spatial stream with the delta modulation method which represents the MCS for a dominant spatial stream in the existing LA subfield and the remaining SS may be given with its corresponding modulation using the modulation order difference from the higher spatial stream. Moreover, separate MCS Tables based on code rates and number of streams were considered, to use an index for showing different combinations of modulation for streams. The following table shows an example provided in the referenced application for 2 spatial streams and code rate 1/2.

TABLE 1
Table for common UEQM combinations for
2 spatial streams and code rate 1/2.

Modulation

| Index | Rate | 1^{st} Stream | 2^{nd} Stream |
|---|---|---|---|
| 0 | 1/2 | 16QAM | QPSK |
| 1 | 1/2 | 16QAM | BPSK |
| 2 | 1/2 | QPSK | BPSK |

However, in current UHR contributions, several UEQM patterns are being suggested to reduce the complexity, limit the number of combinations, and yet improve the performance compared to Equal Modulation (EQM). According to embodiments of the present disclosure, the UEQM patterns that are potentially used might only be based on the number of spatial streams and the modulation order gap between each spatial stream and the base stream. Accordingly, in practice, and according to embodiments, fewer than all possible combinations of UEQM patterns can be implemented. For example, the UEQM pattern in use can be indicated using a reference value, also referred to as an index. The index defines a UEQM pattern and the correspondence between indices and UEQM patterns is known to both transmitter and receiver. Furthermore, indices may be defined for more than two, but fewer than all possible UEQM patterns. Embodiments of the present disclosure are configured in view of this limitation of patterns. For example, a table of possible or most likely patterns can be defined, and the patterns in use can be communicated via an index of the table. This can reduce overhead in communicating the UEQM pattern.

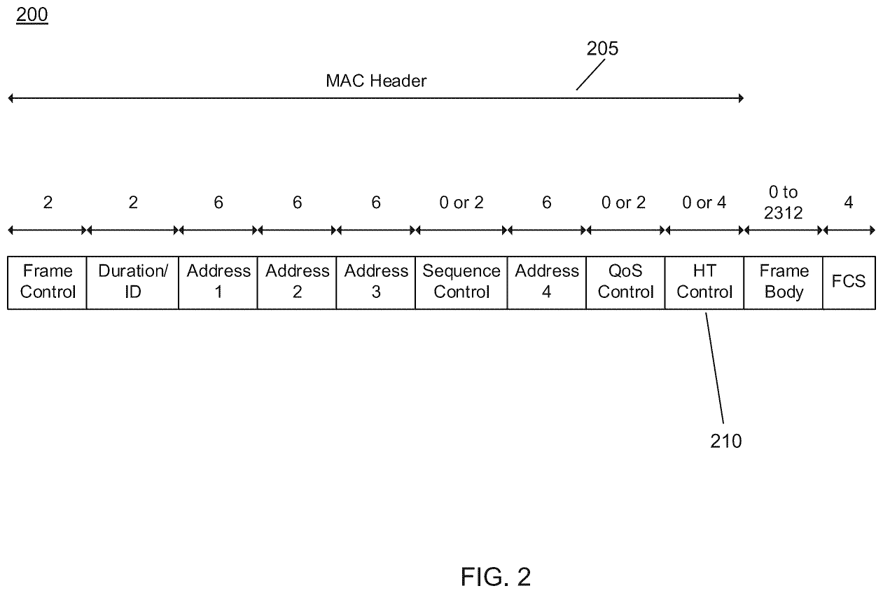

According to IEEE 802.11 systems such as UHR systems (e.g. as in Wi-Fi™ 8), the medium access control (MAC) header 205 in a PPDU, as it is currently defined, includes 9 fields. FIG. 2 shows the general MAC frame 200 format in such an IEEE 802.11 implementation.

The MAC frame 200 may comprise the MAC header 205 as well as a frame body and a frame check sum (FCS) field. The MAC header may comprise fields for: frame control, duration or identification, a first address, a second address, a third address, sequence control, a fourth address, QoS control, and HT control 210.

The HT Control field 210, as illustrated in FIG. 2, is always present in a Control Wrapper frame, QoS Data, and Management frames as determined by the +HTC subfield of the Frame Control field. “+HTC” signifies an extension of standard functionalities, indicating enhanced features designed to support and optimize high-throughput operations in wireless networks. This notation differentiates advanced control capabilities, such as improved handling of frame priorities and power saving mechanisms, from more basic network functions. The format of the HT Control field transmitted by a non-control mode management group (non-CMMG) station (STA) is defined as follows:

TABLE 2
HT Control variants.

| Variant | B0 | B1 | B2-B29 | B30 | B31 |
|---|---|---|---|---|---|
| HT | 0 | HT Control Middle | | AC Constraint | RDG/More PPDU |
| VHT | 1 | 0 | VHT Control | AC Constraint | RDG/More PPDU |
| | | | Middle | | |

| | | | |
|---|---|---|---|
| HE/EHT | 1 | 1 | A-Control |

Table 2 shows the format, by subfields, for three different variants of an HT control field transmitted by the non-CMMG station: a HT variant, a very-high-throughput (VHT) variant, and a high-efficiency/extremely-high-throughput (HE/EHT) variant. Subfields in Table 2 are indicated by their bit positions (e.g., B0, B1, B2 . . . ) and may include a HT control middle subfield, a VHT control middle subfield, an autocorrelation (AC) constraint subfield, a response delay grant (RDG)/more PPDU subfield, and an A-control subfield.

The HT Control field in HE/EHT Variants of IEEE 802.11 carries the Link Adaptation (LA) parameters. The A-Control subfield may be 30 bits in length including 4 bits for Control ID and variable length for Control Information. Control ID indicates 11 different Control fields, and the remaining 5 Control ID are Reserved for future indications, as shown in Table 3.

TABLE 3
Control ID subfield values as of TGbe D5.0.

| | | Length | |
|---|---|---|---|
| | | of the | |
| | | Control | |
| Control | | Information | |
| ID | | subfield | Content of the Control |
| value | Meaning | (bits) | Information subfield |
| 0 | Triggered response | 26 | See 9.2.4.7.1 (TRS |
| | scheduling (TRS) | | Control) |
| 1 | Operating | 12 | See 9.2.4.7.2 (OM |
| | mode (OM) | | Control) |
| 2 | HE link adaptation | 26 | See 9.2.4.7.3 (HLA |
| | (HLA)/EHT link | | Control)/ |
| | adaptation (ELA) | | - |
| | | | 9.2.4.7.11 (ELA Control). |
| | | | (See 9.2.4.7.11 (ELA |
| | | | Control) for dis- |
| | | | ambiguating HLA |
| | | | Control and ELA |
| | | | Control.) |
| 3 | Buffer status | 26 | See 9.2.4.7.4 (BSR |
| | report (BSR) | | Control) |
| 4 | UL power | 8 | See 9.2.4.7.5 (UPH |
| | headroom (UPH) | | Control) |
| 5 | Bandwidth query | 10 | See 9.2.4.7.6 (BQR |
| | report (BQR) | | Control) |
| 6 | Command and | 8 | See 9.2.4.7.7 (CAS |
| | status (CAS) | | Control) |
| 7 | EHT operating | 6 | See 9.2.4.7.8 (EHT OM |
| | mode (EHT OM) | | Control) |
| 8 | Single response | 10 | See 9.2.4.7.9 (SRS |
| | scheduling (SRS) | | Control) |
| 9 | AP assistance | 20 | See 9.2.4.7.10 (AAR |
| | request (AAR) | | Control) |
| 10-14 | Reserved | | |
| 15 | Ones need | 26 | Set to all 1s |
| | expansion | | |
| | surely (ONES) | | |

The Content of the Control Information subfield column of Table 3 refers to “subclauses” for example in the document “IEEE Draft Standard for Information technology—Telecommunications and information exchange between systems Local and metropolitan area networks—Specific requirements-Part 11: Wireless LAN Medium Access Control (MAC) and Physical Layer (PHY) Specifications Amendment: Enhancements for Extremely High Throughput (EHT),” in IEEE P802.11be/D5.0, November 2023, vol., no., pp.1-1045, 3 Jan. 2024.

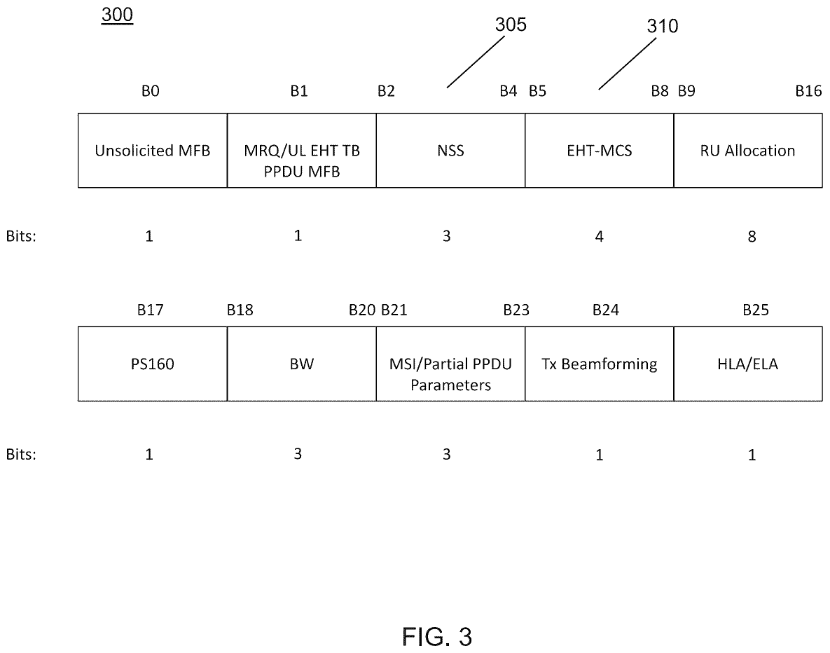

Some Control IDs do not require all the remaining 26 bits for the Control Information. In this case, and according to embodiments, the remaining bits not used for Control Information shall be padded with zeros. Control ID “0010” indicates the HLA/ELA Control field 300 where 26 bits are allocated for Control Information as shown in FIG. 3. The HLA/ELA Control field can be replaced with a substantially equivalent ULA Control field in some embodiments.

The control information in FIG. 3 may comprise subfields for: an unsolicited management frame block (MFB), a management request (MRQ)/uplink (UL) EHT trigger-based (TB) PPDU MFB, a number of spatial streams 305, an EHT-MCS 310, resource unit (RU) allocation, a primary 160 MHz (PS160) subfield, bandwidth (BW), MAC sequence control information (MSI)/partial PPDU parameters, transmitter (Tx) beamforming, and HLA/ELA. Each of these subfields may include one or more bits, at the positions shown in FIG. 3 (e.g., B0, B1, B2 . . . ).

Currently, in a SU-MIMO system, the same MCS is allocated to different spatial streams regardless of their signal-to-noise ratio (SNR) imbalance. This may spoil or otherwise negatively impact the average goodput performance of each channel. Different modulations with similar encoding rate for spatial streams can significantly improve the performance of the system yet keep the complexity within bounds. That is, the majority of bits in a low-density parity-check (LDPC) codeword are transmitted on strong spatial streams with high MIMO gains and high-order modulations. However, it can be seen from FIG. 3 that UEQM is not taken into account in the current format. There is only a single field, i.e. the EHT-MCS field 310 for indicating MCS, which is insufficient for indicating different MCS of different spatial streams. The EHT-MCS field 310 may be replaced with an (e.g. non-EHT) MCS field.

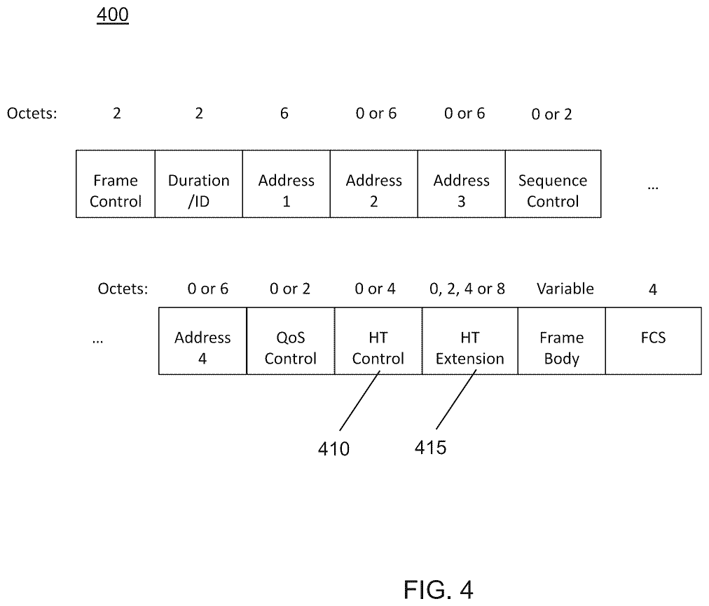

According to embodiments of the present disclosure, in order to indicate UEQM on a per-stream basis, a particular HT Control (HTC) extension is provided for use. The HTC extension can be provided immediately after the HTC field 210 of FIG. 2. This is shown in FIG. 4, Where the HT Extension 415 follows the HT control 410.

In more detail, in an IEEE 802.11 wireless communication system, MIMO communication involving multiple spatial streams with potentially unequal modulation is supported as follows. A transmitter communicates with a receiver using MIMO wireless communication involving multiple spatial streams. The transmitter can be an IEEE 802.11 AP or STA, and the receiver can be another IEEE 802.11 AP or STA. The transmitter prepares and transmits, and the receiver receives and processes, a PPDU having a MAC header. The PPDU is transmitted using a plurality of spatial streams, which includes a base stream and one or more additional stream. The spatial streams are transmitted using modulation types (or MCS) as indicated in the MAC header.

The MAC header includes a HTC field and an HTC extension field. The HTC extension field indicates a type of modulation of each of the spatial streams other than the base stream. The types of modulation of these other spatial streams can be indicated relative to the type of modulation of the base stream. For example, the type of modulation of such an additional spatial stream can be indicated by a numerical value which indicates a degree of difference (offset) between this type of modulation and the modulation type of the base stream. This may be referred to as a modulation order (MO) gap or delta value, as described in more detail below. Modulation order (MO) gap may be a value indicative of the difference in modulation complexity between various transmission channels or spatial streams within wireless systems like MIMO. Modulation order may indicate or correspond to the number of bits that are/may be encoded using a modulation symbol, such as 2 bits in QPSK or 4 bits in 16-QAM, as shown for example in Table 4. A MO gap, therefore, measures the variation in these modulation schemes across different paths, allowing for tailored use of higher modulation orders on stronger signal paths for increased data throughput and lower orders on weaker paths for greater reliability, optimizing channel use and enhancing system performance. The HTC extension field may indicate an entire pattern of modulation types of the spatial streams, relative to the type of modulation of the base stream, via an index to a table or other data structure known to both transmitter and receiver.

The modulation type of the base stream is indicated in the PPDU (e.g. in the MAC header) separately from the HTC extension field. For example, the modulation type of the base stream can be indicated in the EHT-MCS (or just MCS) field 310 as illustrated in FIG. 3.

According to an embodiment, one of the remaining (currently unused) Control ID values as shown in Table 3 is set to the HTC Extension Field. This value may be value 15 (currently set to all ones) or one of the Reserved values, such as values in positions 10 to 14. The HTC Extension Field comes immediately after the HT Control Field in the MAC Header. The length of the HTC Extension field can be 2 bytes, but is not necessarily limited to 2 bytes. The HTC Extension field can be any length such as 4 or 8 bytes. This is illustrated in FIG. 4, which shows a MAC frame 400. The HTC field 410 and the HTC Extension field 415 are shown.

According to embodiments, in the HTC Extension field, the type of the corresponding extension may be indicated using first m bits, which may be referred to as a HTC Extension Type subfield. The HTC Extension Type may come to (e.g. be indicated in) the first subfield of a Control Information field. Referring back to Tables 2 and 3, for the HE/EHT variant, the A-Control subfield of the HT Control field includes a Control ID value and a Control Information subfield. In some embodiments, the HTC Extension Type may be indicated within contents of such a Control Information Subfield. This approach may be used instead of or in addition to indicating the HTC Extension Type using bits of the HTC Extension field 500. For instance, if m is equal to 3, a value of “000” in this subfield may be used to represent ultra high reliability (UHR) link adaptation (LA) Extension. Accordingly, the HTC Extension subfield, when beginning with this first m bits, can be referred to as the UHR LA extension. The remaining bits, depending on the length of the HTC Extension field, may indicate required information according to the corresponding HTC Extension Type. In the previous example, if the HTC Extension Type subfield indicates LA Extension, the remaining bits may specify the LA related parameters. Accordingly, the HTC extension field may begin with a first one or more bits (m bits) indicative that the HTC extension field indicates (according to a predetermined format) the types of modulations of each of the plurality of spatial streams other than the base stream. For clarity, it is noted that the plurality of spatial streams other than the base stream can include just a single spatial stream (in the event that there are two spatial streams, so the set of spatial streams other than the base stream is just one spatial stream.) Thus, the phrase “spatial streams other than the base stream” can be used to emphasize this possibility.

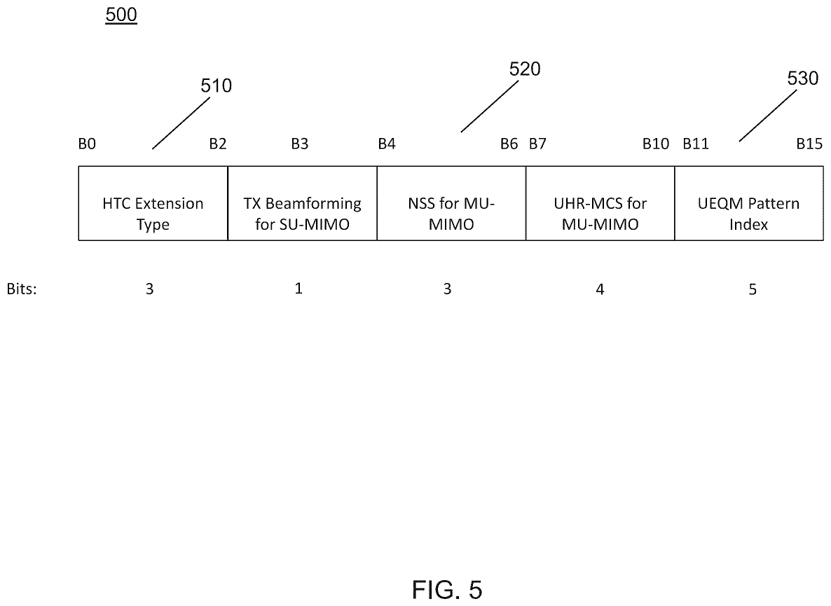

FIG. 5 illustrates the HTC Extension field 500 including HTC Extension Type subfield 510. A UEQM Pattern Index field 530 is also shown. The HTC Extension type 510 may include a set of m bits, where m is a natural integer such as three. An HTC Extension type 510 of “000” may, for example, represent a UHR LA extension. The remaining bits of the HTC Extension field 500 may be used to indicate UEQM parameters, LA parameters, or other information in accordance with the HTC Extension type. These parameters and information may be provided through the following examples of subfields: Tx beamforming for SU-MIMO, an NSS 520 for MU-MIMO, an UHR-MCS (or other MCS field) for MU-MIMO, and the UEQM Pattern Index 530. Each subfield may include one or more bits, at the positions shown in FIG. 5 (e.g., B0, B1, B2 . . . ). It is noted that in FIG. 5, the illustrated number of bits is provided as an example, and this number of bits may be varied.

The HT Control field can be used for different applications as illustrated in “Table 3: Control ID subfield values as of TGbe D5.0.” For example, the HT Control field can be used to support TRS, OM, HE/EHT LA (high efficiency extremely high throughput link adaptation), BSR, etc. Accordingly, the HTC Extension can be used to provide further information regarding any one or more of these applications. As noted previously, the first m bits of the HTC Extension may be used to indicate the type of extension or the application for which the HTC Extension is introduced. The remaining bits can be used to convey parameters or subfields regarding that application.

As an example, assume as above that m=3 and an HTC Extension Type of “000” indicates the extension of LA, referred to herein as UHR LA Extension. In this case, the rest of the bits may be used to convey LA parameters such as MU-MIMO parameters (i.e., MCS and NSS) and UEQM Pattern Index, as described elsewhere herein. These parameters are useful or even required in UHR (Wi-Fi 8) but are not accounted for in the current HE/EHT LA application of HT Control field. Hence, the HTC Extension may be used to carry these parameters.

Various fields as illustrated in the HTC Extension field are described as follows. The Tx beamforming for SU-MIMO field indicates whether MU or SU transmission is used. The NSS for MU-MIMO field may indicate a recommended number of spatial streams for MU-MIMO. The UHR-MCS for MU-MIMO field may indicate a recommended UHR-MCS for MU-MIMO. The UEQM Pattern Index field indicates the index of UEQM pattern as described elsewhere herein.

In various embodiments, B3 of the HTC Extension field 500 (the Tx beamforming for SU-MIMO field) is set to one, it means that SU transmission is used. In that case MU parameters, i.e., B4-B10 can be reserved or repurposed for other SU LA parameters. If B3 is set to zero, it means that MU transmission is used. Hence, UEQM Pattern Index, B11-B15, can be reserved or repurposed for other MU parameters. Details for the MU-MIMO parameters for LA, i.e., NSS for MU-MIMO and UHR-MCS for MU-MIMO, can be found in U.S. Provisional Patent Application No. 63/568,893. Details can also be found for example in the IEEE submission document entitled IEEE.802.11-21/0102r5 “Considerations on Capabilities and Operation Mode: MU-MIMO,” 2021 Jan. 8.

The modulation order (MO) gap, i.e., delta modulation or ΔM, between the i^{th} spatial stream and a base spatial stream can be used to indicate UEQM patterns. Delta modulation expresses the modulation order of a given spatial stream relative to the modulation order of the base stream in a predetermined way, for example:

$$Δ {M}_{i} = \vert ⌈ \frac{MO ( {SS}_{i} ) - MO ( {SS}_{b} )}{2} ⌉ \vert \qquad ( 1 )$$

where SSᵢ and SS_{b} are the i^{th} spatial stream and the base spatial stream, respectively. Equation (1) includes an absolute value operator |·| and a ceiling function operator ┌·┐. The base spatial stream can be the strongest, weakest, or any other spatial steam. The strongest spatial stream can be the spatial stream associated with the largest eigenvalue λ₁. Eigenvalues represent the strength of signal paths between the transmitter and receiver. These values indicate how much data can be transmitted over each path with minimal errors. Higher eigenvalues suggest stronger signal paths that can support higher-order modulation schemes for increased data throughput. In unequal modulation systems, modulation schemes are adapted based on eigenvalues to optimize performance by using stronger channels for higher data rates and weaker channels for more robust transmission. It should be noted that upper (or stronger) streams may have higher or equal MCS when compared to subsequent streams. An example of modulation orders is given in the following table.

TABLE 4
Modulation orders.

| Modulation | Order |
|---|---|
| BPSK | 1 |
| QPSK | 2 |
| 16-QAM | 4 |
| 64-QAM | 6 |
| 256-QAM | 8 |
| 1024-QAM | 10 |
| 4096-QAM | 12 |

It is noted that Equation (1) provides an example expression for Delta modulation or associated modulation orders, and that other formulations may also be used, for example which express a modulation type numerically (or otherwise) relative to a base modulation type.

Accordingly, given the modulation for a base stream and the modulation for another streams, an indication of the difference between the two modulations can be determined, for example according to ΔM as given above. For example, if the base stream is QPSK and the other stream is 64-QAM, the difference between the two modulations is indicated by ΔM=2.

More generally, a MO gap or delta modulation can express a modulation (or modulation order) of a spatial stream using a relative value. The relative value on its own does not fully indicate the modulation (or modulation order). However, by combining (according to a predetermined and known formula) the relative value with an indication of the modulation (or modulation order) of a base stream, the modulation or modulation order of the spatial stream is determined.

As a possible example, the relative value can indicate the modulation order of the spatial stream is specified by k index units away from the modulation order of the base stream, where k can be zero or positive. All modulation orders can be listed in order in a table. To find the modulation order of the spatial stream, the modulation order of the base stream is first found, say at row r. Then, the modulation order of the spatial stream will be at row r+k or r−k, where k is as above. Whether the modulation order of the spatial stream is at row r+k or row r−k can be determined according to whether the spatial stream is stronger or weaker than the base stream. For example, if the spatial stream is stronger than the base stream, it can be assumed to have a higher modulation order.

This use of modulation orders relative to a base stream may allow for an improved communication of the modulation order. For example, in some cases only a limited number of UEQM patterns are actually used in practice. However, these patterns may be relative patterns, i.e. relative to the modulation order of a base stream. The situation is described for example with respect to Tables 5 and 6. Embodiments allow for all such patterns to be communicated in a succinct manner, because knowing the modulation order of the base stream, an indication of such a table to use, and the index into such a table, the UEQM pattern in use can be determined for a variety of potential UEQM patterns.

Tables can be prepared of common patterns or combinations of delta modulations with high probability (e.g. more likely patterns or combinations, or only the patterns or combinations actually used in practice) for different numbers of spatial streams. One can consider an index into the table for each of the combinations which can be presented by n bits in the UHR LA Extension. That is, rather than communicating the differences directly, the row (index) of the table showing these differences can be communicated. The transmitter and receiver, both knowing the table information, can communicate the differences by communicating table row (index) information. For instance, B11-B15 of the HTC extension field 500, i.e. 5 bits, may be used to indicate the UEQM pattern index 530 in FIG. 5. In this case, the number of streams and MCS for the base spatial stream can be indicated in B2-B4 305 and B5-B8 310 of the Control Information of ELA, respectively (refer to FIG. 3). According to the number of streams, the table and indices in the table can be used to demonstrate UEQM pattern. That is, the value in the NSS field 305 can be used to specify which of a set of lookup tables, used by both transmitter and receiver, should be used, and the value in the UEQM pattern index field 530 can be used to specify the appropriate row (index) of the table. Accordingly, a plurality of potential configurations for UEQM patterns are known a priori (i.e. via a predetermined correspondence) to the transmitter and the receiver. This can involve preprogramming the transmitter and receiver with the plurality of potential configurations, as tables or equivalent data structures. Each table may be a separate predetermined correspondence. The appropriate table (or predetermined correspondence) to be used can be selected based on a quantity of spatial streams being used to communicate the PPDU. This quantity can be indicated in the MAC header, as explained above.

Table 5 below provides an example table for use with 2 spatial streams.

TABLE 5
Table for common UEQM patterns for 2 spatial streams.

Delta Modulation

| Index | 1^{st} Stream | 2^{nd} Stream |
|---|---|---|
| 0 | 0 | 0 |
| 1 | 0 | 1 |
| 2 | 0 | 2 |
| 3 | 0 | 3 |

In this example, the strongest spatial stream, e.g. first spatial stream, is considered as the base spatial stream (SS) for which the MCS is indicated in B5-B8 (FIG. 3 element 310) of the Control Information of ELA. The modulation pattern or MCS of the second SS can be determined using the MCS of the base SS and the delta modulation indicated by the UEQM Pattern Index and the corresponding table indicated in Table 5. The latter is determined by the number of spatial streams (NSS) 305 in B2-B4 of the Control Information of ELA as illustrated in FIG. 3.

Below is provided another example for 3 spatial streams. In this example, the strongest stream is considered to be the base stream. In Table 6, a limited number of patterns with high probability (e.g. high likelihood of occurring) are considered. This limits the table size and number of bits required to communicate the row index for the table.

TABLE 6
Table for common UEQM patterns for 3 spatial streams.

| | Delta Modulation | | |
|---|---|---|---|
| Index | 1^{st} Stream | 2^{nd} Stream | 3^{rd} Stream |
| 0 | 0 | 0 | 0 |
| 1 | 0 | 0 | 2 |
| 2 | 0 | 1 | 2 |
| 3 | 0 | 1 | 3 |
| 4 | 0 | 1 | 4 |

Therefore, for example, if the 2^{nd} spatial stream, when compared to the 1^{st} spatial stream, has a value ΔM=1 and the 3^{rd} spatial stream, when compared to the 1^{st} spatial stream, has a value ΔM=3, then the UEQM pattern index 530 is set equal to 3. The receiver receives this UEQM pattern index and determines these values for ΔM. Accordingly, the receiver, knowing the modulation used for the base stream, can determine the modulations used for the other streams. To do so, the receiver determines the modulation orders that would result in such values for ΔM according to Equation (1), and also (e.g. from Table 4) determines the corresponding modulations. Effectively, where Equation (1) specifies ΔM as a function of the modulation orders of the i^{th} spatial stream and the base spatial stream, the (non-relative) modulation order of the i^{th} spatial stream can be determined based on ΔM and the modulation order of the base spatial stream, via an inverse of such a function. The function and its inverse may be computed based on one or more lookup tables. The modulation types themselves can be determined from modulation order based on their definition, for example via Table 4.

Note that Tables 5 and 6 have, as a first entry with index 0, a case where all spatial streams have the same modulation order. Therefore, it is possible in some instances that all spatial streams are modulated in the same manner.

A table can refer to a data structure which indicates multiple modulation patterns for spatial streams, relative to the modulation pattern of a base stream. Each modulation pattern is associated with an index (e.g. the row of the table), and the index can be used to indicate the modulation pattern. The transmitter and receiver both hold an indication of the table. Thus, the index can be used to communicate the modulation pattern (via the UEQM pattern index field 530). In fact, the index can be used to communicate the modulation patters of multiple spatial streams, for example relative to the base stream, because the entry identified by the index can hold multiple values, one for each spatial stream. The values, as stated above, can be MO gap values or other values expressing modulation type or order relative to that of the base stream.

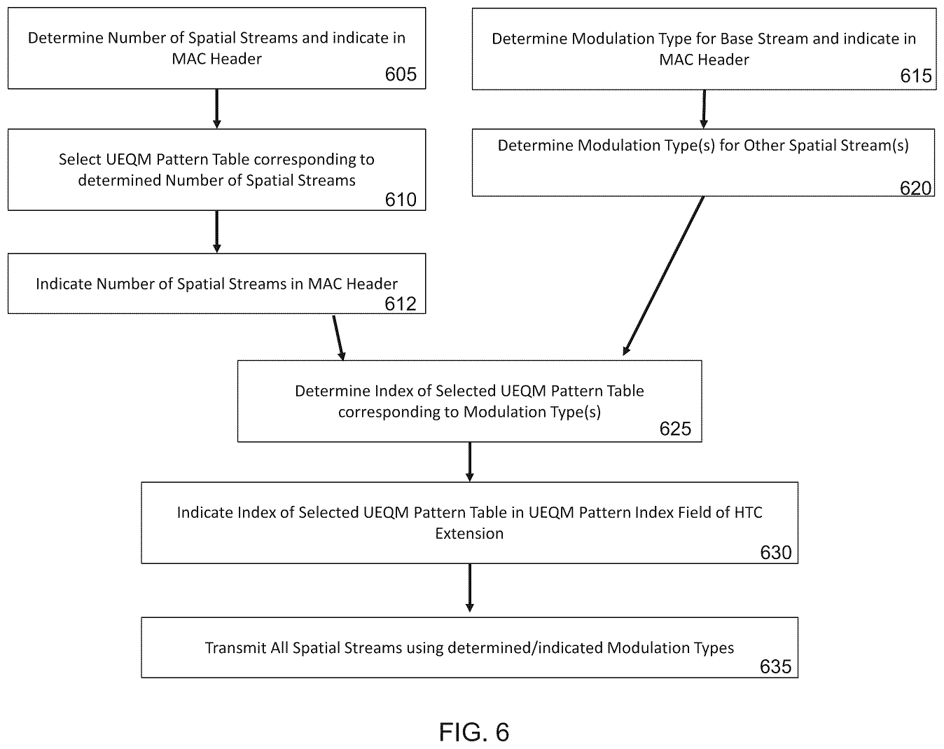

FIG. 6 illustrates operations by a transmitter, according to an embodiment of the present disclosure. The transmitter performs a MIMO communication involving multiple spatial streams with potentially unequal modulations. The transmitter determines 605 a number of spatial streams to be transmitted and selects 610 one of a plurality of tables which corresponds to this number of spatial streams. The transmitter also indicates 612 the number of spatial streams in the MAC header. The transmitter determines 615 a modulation type to be used for the base stream, and indicates this modulation type in the MAC header, for example in the EHT-MCS (or MCS) field 310 of FIG. 3. The transmitter also determines 620 the modulation type(s) to be used for the other spatial stream(s). The transmitter then determines 625 the index of the selected table which corresponds to the (e.g. combination of) modulation type(s) of the other spatial stream(s), relative to the modulation type of the base stream. The transmitter indicates 630 this index in the UEQM pattern index field 530 of the HTC extension field 500. The transmitter also transmits 635 the base stream and the other spatial stream(s) according to the determined (and indicated in the MAC header) modulation types.

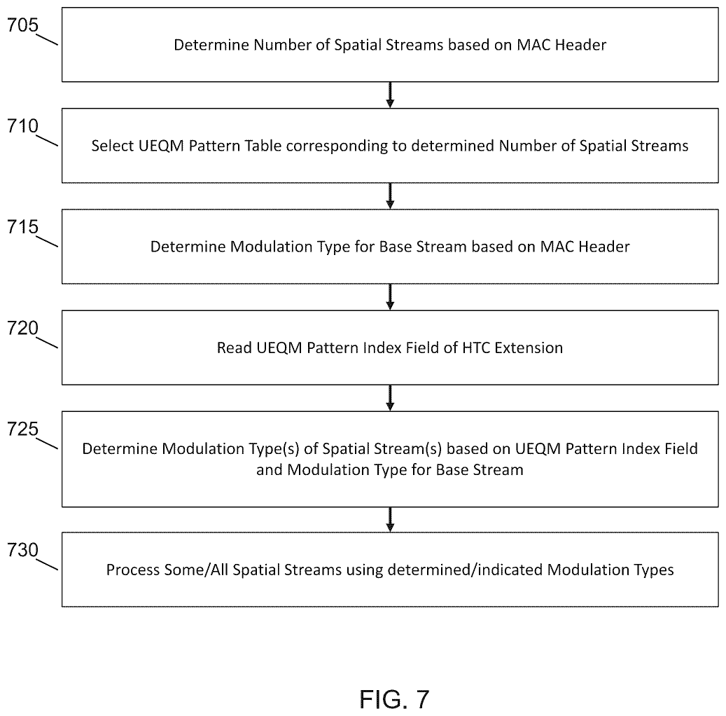

FIG. 7 illustrates operations by a receiver, according to an embodiment of the present disclosure. The receiver also performs a MIMO communication involving multiple spatial streams with potentially unequal modulations. The receiver receives a MAC frame and determines 705 a number of spatial streams based on contents of the MAC header, for example based on field 305 as illustrated in FIG. 3. The receiver then selects 710 one of a plurality of tables which corresponds to this number of spatial streams. The receiver determines 715 a modulation type used for the base stream, for example by reading the EHT-MCS (or MCS) field 310 of FIG. 3. The receiver also reads 720 the contents of the UEQM pattern index field 530 of the HTC extension field 500. The receiver then determines 725 the modulation type(s) of the other spatial stream(s) based on the contents of the UEQM pattern index field and the modulation type used for the base stream. In order to do this, the receiver uses the UEQM pattern index field value to look up the appropriate entry in the selected table. This entry indicates the modulation type(s) of the other spatial stream(s) relative to the modulation type of the base stream (e.g. expressed as a modulation offset or delta). By applying such an offset to the base stream the modulation type(s) for the other spatial stream(s) can be determined. The receiver then processes 730 some or all of the base stream and the other spatial stream(s) according to the determined modulation types.

Where dependencies allow (i.e. where an operation does not depend on output of another operation), various operations of FIGS. 6 and 7 can be performed concurrently or in a different order, rather than sequentially. For example, as shown in FIG. 6, certain operations relating to the number of spatial streams can be parallelized with certain operations relating to modulation type. FIGS. 6 and 7 show one example ordering of operations that may be followed, although this is not necessarily intended to be limiting.

Accordingly, the HTC extension field of the MAC header includes an index indicating one of a plurality of potential configurations for the spatial streams. Each of the plurality of potential configurations is known to both the transmitter and the receiver, e.g. as an entry in a table or other data structure stored in memory. The appropriate table can be selected based on the number of spatial streams, or other relevant information, from a plurality of tables, all of which are known to both transmitter and receiver. Each of the potential configurations indicates corresponding types of modulation for each of the (e.g. plurality of) spatial streams other than the base stream. The aforementioned one of the plurality of potential configurations corresponds to the types of modulations of each of the plurality of spatial streams other than the base stream. There may be only two spatial streams, in which case there is only a single spatial stream other than the base stream.

The plurality of potential configurations as indicated by the table or other data structure, may encompass fewer than all possible configurations. That is, some combinations of modulation types may be omitted from the table or data structure, because such combinations are not used in practice or alternatively are less likely to be used in practice (e.g. with less than a threshold probability).

In various embodiments, each of the potential configurations indicates, for each one of the spatial streams other than the base stream, a difference between the type of modulation of that spatial stream and the type of modulation of the base stream. The indications may thus be made relative to the modulation type of the base stream, e.g. via an offset, delta value, or modulation order (MO) gap. In this way, a single entry (row) in the table can be used to indicate multiple different patterns of modulation, because the base stream can have multiple different corresponding modulation types.

In view of the above, embodiments of the present disclosure provide for assignment of an extension for HT Control field to accommodate UEQM and LA parameters.

Also in view of the above, embodiments of the present disclosure provide for using the first m bits of an HTC Extension field to demonstrate the type of extension.

Also in view of the above, embodiments of the present disclosure provide for the definition and use of tables of common UEQM patterns or combinations with high probability. Different tables for different numbers of spatial streams can be defined and used.

Also in view of the above, in embodiments of the present disclosure, delta modulation values can be adopted to communicate UEQM patterns.

Also in view of the above, in embodiments of the present disclosure, a (e.g. table) index or equivalent lookup or representative value can be used for showing different combinations of delta modulation for streams.

Also in view of the above, in embodiments of the present disclosure, a subfield in UHR LA Extension with n bits can be used for indicating a UEQM Pattern Index.

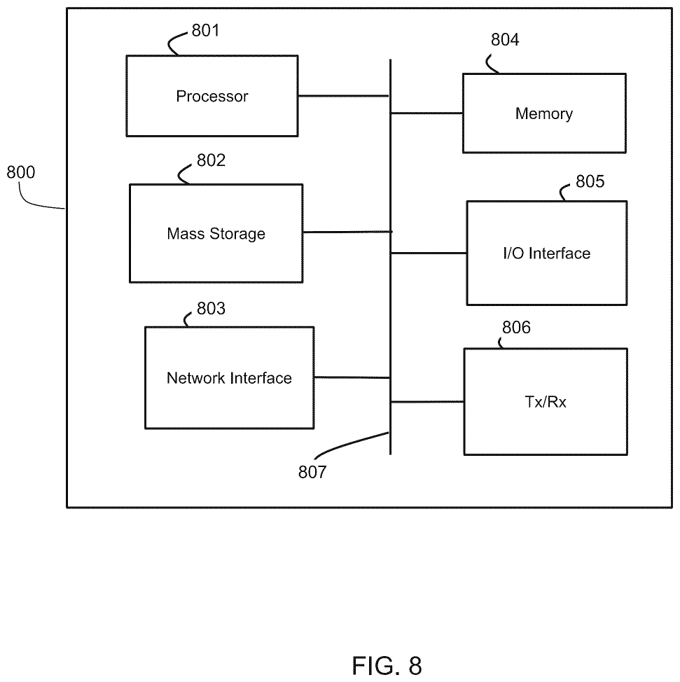

FIG. 8 is a schematic diagram of an electronic device 800 that may perform any or all of operations of the above methods and features explicitly or implicitly described herein, according to different embodiments of the present application. For example, a computer equipped with network function may be configured as electronic device 800. In some embodiments, electronic device 800 can be a device that connects to the network infrastructure over a radio interface, such as a mobile phone, smart phone or other such device that may be classified as user equipment (UE). In some aspects, the electronic device 800 may be a Machine Type Communications (MTC) device (also referred to as a machine-to-machine (m2m) device), or another such device that may be categorized as a UE despite not providing a direct service to a user. In some embodiments, electronic device 800 is capable of Wi-Fi connectivity, including the transmission and reception of Wi-Fi frames. In some embodiments, electronic device 800 can function as an access point or a station in a Wi-Fi network and is equipped to perform channel estimation for optimizing wireless communication. In some embodiments, electronic device 800 is designed to support Wi-Fi 8 technology and future advancements. In some embodiments, electronic device 800 may perform one or more operations in one or more embodiments described herein. In some embodiments, the electronic device 800 may be a UE, an IEEE 802.11 AP, an IEEE 802.11 STA, or the like as appreciated by a person skilled in the art.

As shown, the electronic device 800 may include a processor 801, such as a Central Processing Unit (CPU) or specialized processors such as a Graphics Processing Unit (GPU) or other such processor unit, memory 804, non-transitory mass storage 802, input-output interface 805, network interface 803, and a transceiver 806, all of which are communicatively coupled via bi-directional bus 807. According to certain embodiments, any or all of the depicted elements may be utilized, or only a subset of the elements. Further, electronic device 800 may contain multiple instances of certain elements, such as multiple processors, memories, or transceivers. The transceiver may include a separate transmitter and receiver, or just one of the transmitter and receiver. Also, elements of the hardware device may be directly coupled to other elements without the bi-directional bus. Additionally, or alternatively to a processor and memory, other electronics, such as integrated circuits, may be employed for performing the required logical operations.

The memory 804 may include any type of non-transitory memory such as static random access memory (SRAM), dynamic random access memory (DRAM), synchronous DRAM (SDRAM), read-only memory (ROM), any combination of such, or the like. The mass storage element 1430 may include any type of non-transitory storage device, such as a solid state drive, hard disk drive, a magnetic disk drive, an optical disk drive, USB drive, or any computer program product configured to store data and machine executable program code. According to certain embodiments, the memory 804 or mass storage 802 may have recorded thereon statements and instructions executable by the processor 801 for performing any of the aforementioned method operations described above. Rather than a general purpose processor, the processor 801 may be replaced by suitable processing electronic components, such as digital circuitry, analog circuitry, or a combination thereof, for example in an application specific integrated circuit or other integrated circuit, or a microchip or chipset, or the like. In such cases, if not needed, the memory can be omitted. If the memory is omitted, tables as described herein may be stored in fixed circuitry.

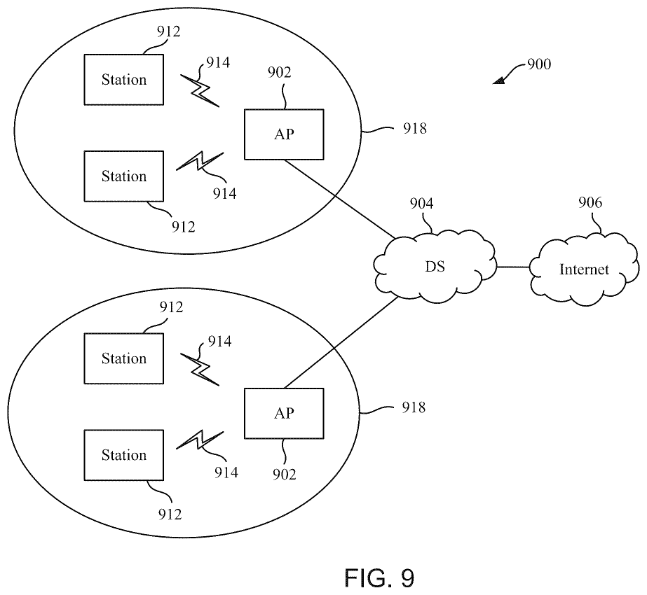

FIG. 9 illustrates a communication system 900, according to an embodiment of the present application. The communication system 900 may be a WI-FI™ system built under relevant standards, such as IEEE 802.11 standard, for example, for a WLAN prioritizing UHR. The communication system 900 includes a plurality of interconnected networking devices 902, such as a plurality of interconnected access points (APs such as WI-FI 8 APs; which may also be referred to as “base stations”) forming a distribution system (DS) 904 which is connected to other networks, such as the Internet 906, which may include a network of computers and subnets (intranets) or both, and incorporate protocols, such as Internet Protocol (IP), Transmission Control Protocol (TCP), User Datagram Protocol (UDP), and/or the like.

Each AP 902 is in wireless communication with one or more mobile or stationary stations 912 (STAs) through respective wireless channels 914 for providing wireless network connections thereto. Herein, the APs 902 and STAs 912 may be considered as different types of network nodes (or simply “nodes”) of the communication system 900. Together, each AP 902 and the STAs 912 connected thereto form a cell or basic service set (BSS) 918.

In embodiments, the STAs 912 may be any suitable wireless device that may join the communication system 900 via an AP 902 for wireless operation. In various embodiments, a STA 912 may be a wireless electronic device used by a human or user (such as a smartphone, a cellphone, a personal digital assistant (PDA), a laptop, a desktop computer, a tablet, a smart watch, a consumer electronics device, and/or the like). A STA 912 may be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation or application, the STA 912 may be movable autonomously or under the direct and/or remote control of a human, or may be positioned at a fixed position.

In some embodiments, a STA 912 may be a multimode wireless electronic device capable of operation according to multiple radio access technologies and incorporate multiple transceivers necessary to support such.

In embodiments, some or all of the STAs 912 include functionality for communicating with different wireless devices and/or wireless networks via different wireless links using different wireless technologies and/or protocols. Instead of wireless communication (or in addition thereto), some or all of STAs 912 may communicate via wired communication channels to other devices or switches (not shown), and to the Internet 906. For example, a plurality of STAs 912 (such as STAs 912 in proximity with each other) may communicate with each other directly via suitable wired or wireless sidelinks.

In the communication between the AP 902 and the STA 912, a transmission from the STA 912 to the AP 902 may typically be denoted as an uplink (UL), and the wireless channel used therefor is denoted an uplink channel. A transmission from the AP 902 to the STA 912 may typically be denoted as a downlink (DL), and the wireless channel used therefor is denoted a downlink channel. Suitable modulation technologies may be used for communication between the AP 902 and the STA 912. For example, in some embodiments, orthogonal frequency-division multiplexing (OFDM) may be used wherein the channel 914 is partitioned into a plurality orthogonal subchannels for communication between the AP 902 and the STA 912. In embodiments where a plurality of STAs 912 is in communication with a same AP 902, suitable multiple-access technologies may be used. For example, in some embodiments, orthogonal frequency-division multiple access (OFDMA) may be used for communication between the AP 902 and STAs 912.

Some wireless communication systems use OFDMA for multiple access. Generally, OFDMA uses OFDM for multiple users to transmit data at the same time.

For example, a device, such as an AP 902 or an STA 912, transmits data using PPDUs. A PPDU contains a preamble and a data field containing an OFDM symbol. As readily understood by a person skilled in the art, an OFDM symbol combines data elements into a plurality of subcarriers (also referred to as “tones”) and uses the so-called “cyclic prefix” for combating inter-symbol interferences.

In embodiments, the wireless communication system 900 or more specifically a one or more AP 902 or one or more STA 912 thereof may use DRUs that may include non-consecutive subcarriers or tones that substantially span the whole BW. Thus, the subcarriers of the DRU may be allocated across the entire OFDMA BW.

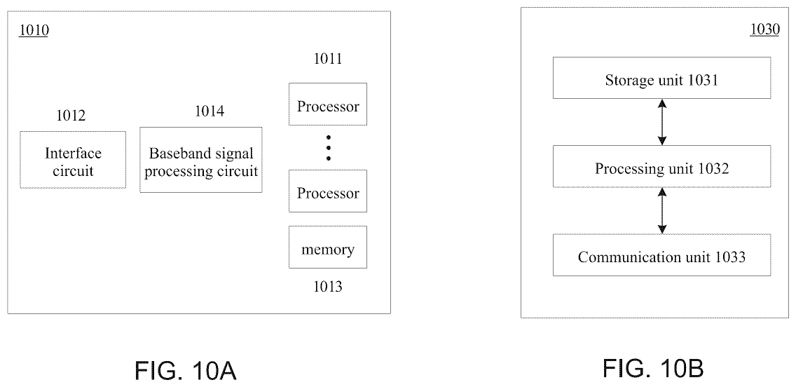

FIG. 10A illustrates an example apparatus 1010, according to an embodiment of the present application. The apparatus 1010 may be a communication device or an apparatus implemented in a communication device in one or more embodiments described herein. For example, the apparatus implemented in a communication device may be an integrated circuit, which in some contexts may be known by other colloquial names, such as chip, modem, modem chip, baseband chip, or baseband processor. In some implementations, one or more integrated circuits can be packaged into a system-on-chip, a system-in-package, or a multi-chip module. The apparatus may comprise one or more integrated circuits or comprise one or more integrated circuits and other discrete components. In some implementations, the apparatus 1010 may be similar to or a module in apparatus 800.

In an example, the apparatus 1010 may include one or more processors/processor cores 1011, and an interface circuit 1012. The apparatus 1010 may further include a memory 1013. The one or more processors/processor cores 1011 are configured to process signals and execute one or more communication protocols. The memory 1013 is configured to store at least a part of corresponding computer program instructions and/or data. In an example, the one or more processors (or processor cores) 1011 execute the computer program instructions stored in the memory 1013 to implement related operations (for example, inputting, outputting, receiving, and transmitting) in the foregoing method embodiments. In some implementations, the memory 1013 being configured to store the corresponding computer program instructions and/or data may mean that the memory 1013 is configured to store all of the corresponding computer program instructions and/or data for execution by the one or more processors/processor cores 1011. In some implementations, the memory 1013 being configured to store the corresponding computer program instructions and/or data may mean that the memory 1013 is configured to store a part of the corresponding computer program instructions and/or data. For example, the part of the corresponding computer program instructions and/or data include computer program instructions and/or data that need to be currently executed by the one or more processors/processor cores 1011. Thus, the memory 1013 may store different parts of computer program instructions and/or data for a plurality of times for the one or more processors (or processor cores) 1011 to perform related operations in the foregoing method embodiments. As a communication interface, the interface circuit 1012 is configured to implement communication with another component. For example, the interface circuit 1012 may communicate a signal with other apparatus/system such as a radio frequency processing apparatus, or processor system. Optionally, to reduce a load of the processor core, a baseband signal processing circuit 1014 may be also disposed to implement processing of at least a part of baseband signals, including signal demodulation, modulation, encoding, decoding, or the like.

Apparatus 1010 may be processor 801 in apparatus 800, in some scenario, or included in processor 801 in apparatus 800. Apparatus 1010 may be or include a baseband chip. In some implementations, the apparatus 1010 may be independently packaged into a chip. In some implementations, the apparatus 800 includes different types of chips. The apparatus 1010 may be packaged into a processor chip (for example, a system on chip (SoC) or a system in package (SIP)) with different types of chips. In some implementations, the apparatus 1010 may be packaged into a chip with some or all of circuits of a radio frequency processing system that may further included in the apparatus 800.

FIG. 10B illustrates another example apparatus 1030, according to an embodiment of the present application. Apparatus 1030 may include corresponding modules or units configured to implement methods and/or embodiments described herein. In some implementations, the apparatus 1030 includes a processing unit 1032 and a communication unit 1033. Optionally, the apparatus 1030 may further include a storage unit 1031 configured to store apparatus program code (or instructions) and/or data.

In some embodiments, the apparatus 1030 may be a module, or a circuit or a chip responsible for a communication function in apparatus 800. In some implementations, apparatus 1030 may be implemented as apparatus 800, accordingly, the processing unit 1032 is implemented as processor 801, the communication unit 1033 is implemented as transceiver 806, and the storage unit 1031 is implemented as memory 804.

In some implementations, a function of the apparatus 1030 may be implemented by one or more processors. Specifically, the processor may include a modem chip, or a SoC chip or a SIP chip that includes a modem core. A function of the communication unit 1033 may be implemented by a transceiver circuit.

In some implementations, when the apparatus 1030 is a circuit or a chip that is responsible for a communication function, for example, a modem chip, a SoC chip or SIP chip that includes a modem core, a function of the processing unit 1032 may be implemented by a circuit system that is in the chip and that includes one or more processors or processor cores. A function of the communication unit 1033 may be implemented by an interface circuit or a data transceiver circuit on the foregoing chip.

Embodiments of the present application can be implemented using electronics hardware, software, or a combination thereof. In some embodiments, the application is implemented by one or multiple computer processors executing program instructions stored in memory. In some embodiments, the application is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. The specification and drawings are, accordingly, to be regarded simply as an illustration of the application as defined by the appended claims, and are contemplated to cover any and all modifications, variations, combinations or equivalents that fall within the scope of the present application. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present application may be implemented by using hardware only or by using software and a necessary universal hardware platform. Based on such understandings, the technical solution of the present application may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the embodiments of the present application. For example, such an execution may correspond to a simulation of the logical operations as described herein. The software product may additionally or alternatively include a number of instructions that enable a computer device to execute operations for configuring or programming a digital logic apparatus in accordance with embodiments of the present application.

Although the present application has been described with reference to specific features and embodiments thereof, it is evident that various modifications and combinations can be made thereto without departing from the application. The specification and drawings are, accordingly, to be regarded simply as an illustration of the application as defined by the appended claims, and are contemplated to cover any and all modifications, variations, combinations or equivalents that fall within the scope of the present application.

Various acronyms and abbreviations used herein are indicated in the following Table.

TABLE 7

| | Acronym/Abbreviation/ |
|---|---|
| Full Name | Initialism |
| Transmitter | TX |
| Receiver | RX |
| Station | STA |
| Up Link | UL |
| Down Link | DL |
| Multi User | MU |
| Single User | SU |
| Multiple Input Multiple Output | MIMO |
| Single Input Single Output | SISO |
| Multi User Multiple Input Multiple Output | MU-MIMO |
| Single User Multiple Input Multiple Output | SU-MIMO |
| Signal to Noise Ratio | SNR |
| Beamforming | BF |
| Bandwidth | BW |
| Modulation and Coding System | MCS |
| High Throughput | HT |
| HE Link Adaptation | HLA |
| EHT Link Adaptation | ELA |
| High Efficiency | HE |
| High Throughput Control | HTC |
| Extremely High Throughput | EHT |
| Ultra-High Reliability | UHR |
| Medium Access Control Layer | MAC |
| MAC Sequence Control Information | MSI |
| Singular Value Decomposition | SVD |
| Physical Layer Protocol Data Unit | PPDU |
| Frame Check Sum | FCS |
| Quality of Service | QoS |
| Spatial Stream | SS |
| Response Delay Grant | RDG |
| Autocorrelation | AC |
| Equal Modulation | EQM |
| Unequal Modulation | UEQM |
| Identification | ID |
| International Electrical and Electronic | IEEE |
| Engineering | |
| Orthogonal Frequency Division | OFDM |
| Multiplexing | |
| Orthogonal Frequency Division Multiple | OFDMA |
| Access | |
| Link Adaptation | LA |
| Triggered Response Scheduling | TRS |
| Operating Mode | OM |
| Buffer Status Report | BSR |
| UL Power Headroom | UPH |
| Bandwidth Query Report | BQR |
| Command and Status | CAS |
| EHT Operating Mode | EHT OM |
| Single Response Scheduling | SRS |
| AP Assistance Request | AAR |
| Ones Need Expansion Surely | ONES |
| Physical Layer | PHY |
| Management Request | MRQ |
| Management Frame Block | MFB |
| Trigger-based | TB |
| Resource Unit | RU |
| Low-Density Parity-Check | LDPC |
| Access Point | AP |
| Station | STA |
| Modulation Order | MO |
| Number of Spatial Streams | NSS |
| Binary Phase Shift Keying | BPSK |
| Quadrature Phase Shift Keying | QPSK |
| Quadrature Amplitude Modulation | QAM |
| Vert-high-throughput Variant | VHT |
| Machine-to-Machine | m2m |
| User Equipment | UE |
| Static Random Access Memory | SRAM |
| Dynamic Random Access Memory | DRAM |
| Synchronous DRAM | SDRAM |
| Read-only Memory | ROM |
| Distribution System | DS |
| Internet Protocol | IP |
| Transmission Control Protocol | TCP |
| User Datagram Protocol | UDP |
| Basic Service Set | BSS |
| Internet-of-things | IoT |
| Wireless Transmit/Receive Unit | WTRU |
| System on Chip | SoC |
| System in Package | SIP |
| Field Programmable Gate Arrays | FPGAs |
| Application Specific Integrated Circuits | ASICs |

What is claimed is:

1. A transmitter in an IEEE 802.11 wireless communication system, the transmitter for communicating with a receiver using a multiple input multiple output (MIMO) communication involving a plurality of spatial streams, at least two of the spatial streams potentially having unequal modulation (UEQM) relative to one another, the transmitter configured to:
transmit a physical layer protocol data unit (PPDU) having a medium access control (MAC) header comprising a high throughput control (HTC) field and a HTC extension field, the HTC extension field indicating a type of modulation of each of the spatial streams other than a base stream of the plurality of spatial streams;
transmit each of the spatial streams, other than the base stream, according to the type of modulation corresponding thereto, as indicated in the HTC extension field; and
transmit the base stream according to a type of modulation as indicated in the PPDU separately from the HTC extension field.

2. The transmitter of claim 1, wherein the HTC extension field indicates the type of modulation of each of the spatial streams other than the base stream, relative to the type of modulation of the base stream.

3. The transmitter of claim 1, wherein the HTC extension field begins with a first one or more bits indicative that the HTC extension field indicates, according to a predetermined format, the types of modulations of each of the spatial streams other than the base stream.

4. The transmitter of claim 1, wherein the HTC extension field includes an index indicating one of a plurality of potential configurations, each of the plurality of potential configurations being known to the receiver and corresponding to potential types of modulation for each of the spatial streams other than the base stream, and said one of the plurality of potential configurations corresponds to the types of modulations of each of the spatial streams other than the base stream.

5. The transmitter of claim 4, wherein the plurality of potential configurations includes less than all possible configurations corresponding to all possible combinations of modulation types of each of the spatial streams other than the base stream.

6. The transmitter of claim 5, wherein the plurality of potential configurations includes a subset of more likely ones of the all possible configurations.

7. The transmitter of claim 4, wherein each of the plurality of potential configurations indicates, for each one of the spatial streams other than the base stream, a difference between the type of modulation of said one of the spatial streams other than the base stream and the type of modulation of the base stream.

8. The transmitter of claim 7, wherein the difference is expressed as a modulation order gap.

9. The transmitter of claim 4, wherein the plurality of potential configurations is known to the transmitter and the receiver via a predetermined correspondence, the predetermined correspondence further depending on a quantity of the plurality of spatial streams.

10. A receiver in an IEEE 802.11 wireless communication system, the receiver for communicating with a transmitter using a multiple input multiple output (MIMO) communication involving multiple spatial streams, at least two of the spatial streams potentially having unequal modulation (UEQM) relative to one another, the receiver configured to:
receive a physical layer protocol data unit (PPDU) having a medium access control (MAC) header comprising a high throughput control (HTC) field and a HTC extension field, the HTC extension field indicating a type of modulation of each of the spatial streams other than a base stream of the plurality of spatial streams;
receive and process each of the spatial streams, other than the base stream, according the type of modulation corresponding thereto, as indicated in the HTC extension field; and
receive and process the base stream according to a type of modulation as indicated in the PPDU separately from the HTC extension field.

11. The receiver of claim 10, wherein the HTC extension field indicates the type of modulation of each of the spatial streams other than the base stream, relative to the type of modulation of the base stream.

12. The receiver of claim 10, wherein the HTC extension field begins with a first one or more bits indicative that the HTC extension field indicates, according to a predetermined format, the types of modulations of each of the spatial streams other than the base stream.

13. The receiver of claim 10, wherein the HTC extension field includes an index indicating one of a plurality of potential configurations, each of the plurality of potential configurations being known to the receiver and corresponding to potential types of modulation for each of the spatial streams other than the base stream, and said one of the plurality of potential configurations corresponds to the types of modulations of each of the spatial streams other than the base stream.

14. The receiver of claim 13, wherein the plurality of potential configurations includes less than all possible configurations corresponding to all possible combinations of modulation types of each of the spatial streams other than the base stream.

15. The receiver of claim 14, wherein the plurality of potential configurations includes a subset of more likely ones of the all possible configurations.

16. The receiver of claim 13, wherein each of the plurality of potential configurations indicates, for each one of the spatial streams other than the base stream, a difference between the type of modulation of said one of the spatial streams other than the base stream and the type of modulation of the base stream.

17. The receiver of claim 16, wherein the difference is expressed as a modulation order gap.

18. The receiver of claim 13, wherein the plurality of potential configurations is known to the transmitter and the receiver via a predetermined correspondence, the predetermined correspondence further depending on a quantity of the plurality of spatial streams.

19. A method performed by a transmitter in an IEEE 802.11 wireless communication system, the transmitter for communicating with a receiver using a multiple input multiple output (MIMO) communication involving a plurality of spatial streams, at least two of the spatial streams potentially having unequal modulation (UEQM) relative to one another, the method comprising:
transmitting a physical layer protocol data unit (PPDU) having a medium access control (MAC) header comprising a high throughput control (HTC) field and a HTC extension field, the HTC extension field indicating a type of modulation of each of the spatial streams other than a base stream of the plurality of spatial streams;
transmitting each of the spatial streams, other than the base stream, according to the type of modulation corresponding thereto, as indicated in the HTC extension field; and
transmitting the base stream according to a type of modulation as indicated in the PPDU separately from the HTC extension field.

20. A method performed by a receiver in an IEEE 802.11 wireless communication system, the receiver for communicating with a transmitter using a multiple input multiple output (MIMO) communication involving multiple spatial streams, at least two of the spatial streams potentially having unequal modulation (UEQM) relative to one another, the method comprising:
receiving a physical layer protocol data unit (PPDU) having a medium access control (MAC) header comprising a high throughput control (HTC) field and a HTC extension field, the HTC extension field indicating a type of modulation of each of the spatial streams other than a base stream of the plurality of spatial streams;
receiving and processing each of the spatial streams, other than the base stream, according the type of modulation corresponding thereto, as indicated in the HTC extension field; and
receiving and processing the base stream according to a type of modulation as indicated in the PPDU separately from the HTC extension field.
